(19) United States
(12) Patent Application Publication
(10) Pub. No.: US 2017/0323310 A1
(43) Pub. Date: Nov. 9, 2017

(54) MOBILE-BASED COMMON PLATFORM ENABLING ELECTRONIC OUTLETS FOR COMPANIES

(71) Applicant: ITTIAM SYSTEMS PTE. LTD., SINGAPORE (SG)

(72) Inventor: SATTAM DASGUPTA, Bangalore (IN)

(21) Appl. No.: 15/365,981

(22) Filed: Dec. 1, 2016

(30) Foreign Application Priority Data
May 6, 2016 (IN) 201641015920

(51) Int. Cl. G06Q 30/02; H04L 29/08; G06Q 30/06

(52) U.S. Cl. CPC G06Q 30/0201; H04L 67/306; G06Q 30/0601; H04L 67/10; H04L 67/22

(57) ABSTRACT

In one example, a method for providing a common platform enabling electronic outlets for companies is described. A plurality of companies and users may be enabled to subscribe with a cloud-based server. A mobile device of a user may be authenticated when the user logs-in through a client application running on the mobile device. A plurality of electronic outlets associated with the plurality of companies may be provided on a user interface of the mobile device of the user through the client application running on the mobile device. A selection of a first electronic outlet associated with a first company of the plurality of electronic outlets may be received. Benefit data specific to the first electronic outlet may be provided on the user interface of the mobile device via the client application upon selecting the first electronic outlet.

### RELATED APPLICATION

Benefit is claimed under 35 U.S.C. 119(a) to Indian Patent Application Serial No. 201641015920 entitled “A MOBILE BASED COMMON PLATFORM FOR OFFLINE BUSINESSES, OFFERING VIRTUAL SHOWROOMS FOR MARKETING, ENGAGING, ENROLLING CUSTOMERS” by ITTIAM SYSTEMS PTE. LTD. filed on May 6, 2016.

### TECHNICAL FIELD

The present disclosure generally relates to customer engagement, and particularly to mobile-based common platform enabling electronic outlets for companies.

### BACKGROUND

Businesses/companies may often operate customer loyalty programs to reward selected customers such as customers who frequently shop in the business and/or those customers who spend substantial amounts of money in the business. Such loyalty programs can offer discounts, customized offers, and the like as rewards to the selected customers based on their previous purchase data. Coupons may be issued by companies to be used in retail stores or in online shopping as a part of sales promotions. They are often widely distributed through mail, magazines, newspapers, Internet, or coupon books directly from the retailer, and mobile devices such as cell phones.

The number of users using mobile devices such as smartphones and tablets is significantly increasing. Also, an amount of time people spending on these mobile devices to access the Internet is increasing. Thereby, making mobile device an excellent means for businesses to reach out to their consumers. The businesses may communicate information about product or services, offers, feedback and the like through a web browser or a client application residing in the mobile device. Further, mobile applications may enable businesses to track consumers and collect data associated with behavior pattern of the customers through associated client applications.

### BRIEF DESCRIPTION OF THE DRAWINGS

Examples are described in the following detailed description and in reference to the drawings, in which:

FIG. 1A illustrates an example system including a cloud-based server enabling electronic outlets for companies/businesses to market, engage, and/or enroll customers;

FIG. 1B illustrates an example block diagram illustrating major components of a customer engagement engine residing in the cloud-based server, such as shown in FIG. 1A;

FIG. 2 illustrates an example process flow between the components of the example system, such as shown in FIG. 1A;

FIG. 3A illustrates an example user interface depicting electronic outlets for businesses;

FIG. 3B illustrates an example user interface depicting customer engagement including campaigns specific to a business;

FIG. 3C illustrates an example user interface depicting a screen where users can leave comments about a campaign associated with a brand;

FIG. 4 illustrates an example user interface depicting a social networking capability to enable campaigns of the businesses to be shared across users and to enable conversation between customers on the campaigns;

FIG. 5 illustrates an example flow chart of a method for providing a mobile-based common platform offering electronic outlets for companies; and

FIG. 6 illustrates a block diagram of an example computing device to provide a mobile-based common platform offering electronic outlets for companies.

### DETAILED DESCRIPTION

Embodiments described herein may provide a system for mobile-based common platform offering electronic outlets/presence/channels for companies. The system may provide the mobile-based common platform for the companies/businesses to have the company-specific customer engagement. The term “company” refers to a “brand manufacturer” or “business” for selling products or services to customers and provide offers, receive feedback and the like to/from the customers. Each company may be associated with an electronic outlet. The term “electronic outlet” may refer to an online/virtual store that enables customers to browse the company's campaigns about news updates, new arrivals, benefit data (e.g., offers), and the like. Further, each company may have one or more company outlets. The term “company outlet” may refer to a place of business usually owned and operated by a retailer or a manufacturer or its franchises. For example, the company outlet may include a retail store, a supermarket, a grocery store, a shopping mall, a department store, a showroom, a gym, a spa, a restaurant, a hotel and the like associated with the company.

Typically, online businesses may have the natural advantage of desktop computers and mobiles since their business model might be built on the Internet, i.e., either accessed using a website or a client application. For offline businesses, however, presence on mobile may not be a part of day to day operation and may be an additional investment and overhead. In addition, the mobile application world is fiercely competitive and rapidly expanding. Hence, securing download and preventing uninstall of the mobile applications can be a challenge given that users may retain a limited number of applications and use even fewer applications. Further, the customers may have to install client applications associated with each of the businesses on the mobile device, which may cause inconvenience and consume significant amount of memory in the mobile device and limits the maximum number of applications that can be installed on the mobile device.

Businesses may communicate information about products or services, offers, feedback and the like through a client application residing in customer's mobile device. Each business may have its own application and may vie for the customers, resulting in fragmentation of the user base associated with each business. Advertisement in other client applications may be an option but such advertisements may not provide a dedicated round-the-clock presence and may not secure the same visibility, engagements and analytics.

Examples described herein may provide a client application running on customers' mobile devices which are communicatively connected with a central cloud-based server having a storage unit. Further, the system includes vendor devices (e.g., mobile device(s), desktop personal computers (PCs) and the like) in the companies which are communicatively connected to the cloud-based server. The vendor devices may have an Internet connection and have an application or browser based application for managing the customer engagement. The client application can be a mobile application or a web-browser based application running on the mobile device.

The cloud-based server may enable the plurality of companies and the users to subscribe with the cloud-based server. Further, the cloud-based server may include a storage unit to store information related to subscribed users, subscribed companies, and benefit data specific to the subscribed companies. The benefit data specific to the subscribed companies may be obtained from respective vendor devices associated with the companies and stored in the storage unit associated with the cloud-based server. Furthermore, the cloud-based server may provide a plurality of electronic outlets associated with the plurality of companies (e.g., offline businesses) on a user interface of the mobile device through the client application, receive a selection of a first electronic outlet associated with a first company of the plurality of electronic outlets, and provide benefit data specific to the first electronic outlet to the mobile device via the client application upon receiving selection of the first electronic outlet. The cloud-based server and service may provide the electronic outlets an ability to directly market to and engage with the customers.

The cloud-based server may direct targeted campaigns specific to the companies to engage the customer depending on the customer's profile and past engagement pattern. The scope of the campaigns includes, but not limited to, generally or selectively communicate offers to target customer base, news of arrival of new items or services, news and communication regarding the business, enrollment in memberships, extend the electronic memberships, availing offers, and managing loyalty programs.

Also, the cloud-based server can capture customers' demographic and behavioral analytics associated with the customers within and across companies and company outlets. The captured information may be collected and used to improve quality of marketing, engagement, offerings, and reward or loyalty programs or devise new strategies and the like. In another example, the cloud-based server may build the client application around a social networking platform to enable the campaigns of the business to be shared with other users of the social network and hence can be scaled to a significantly larger audience and ability to engage with them in promoting the businesses.

Being a platform and hence a common system for multiple companies, the example cloud-based server described herein may bring customers of many companies together, increasing cross-business-visibility and particularly, reducing fragmentation of the customer base across multiple company specific engagement solutions (e.g. applications) on the customers' mobile devices. In existing methods, individual company-specific solutions may have to compete against each other for being retained and used.

Examples described herein may enable electronic outlets to market products and services and engage with the customers at different levels of interaction. Examples described herein may enable electronic outlets to offer electronic membership and membership upgrades to its followers and members. Examples described herein may enable electronic outlets to provide generic or targeted campaign for engagement (e.g., offers, news of new arrivals, communication in general, and the like) with the customers by the business (i.e., brand) in general. Examples described herein may promote electronic outlets in overall listing. Examples described herein may enable electronic outlets to extend offers to a specific set of followers and/or members. Examples described herein may enable electronic outlets to extend loyalty programs to a specific set of followers and/or members.

Examples described herein may enable cloud-based server to design a reward program across the electronic outlets based on customer analytics. Examples described herein may enable users to call a common or a specific phone number relevant to an offer being marketed. Examples described herein may enable users to purchase from the relevant e-commerce website or application. Examples described herein may enable customers to have capabilities to follow or like an electronic outlet, like a campaign from the electronic outlet, promote/share campaigns within his or her social interaction network, boost (or recommend) an offer or communication from the electronic outlet to his or her friends such that the offer or communication to be prioritized in their electronic outlet listing and the like.

The terms “company”, “brand” and “business” are used interchangeably throughout the document and may refer to “manufacturer” or “business” for selling products or services to customers and provide offers, receive feedback and the like to/from the customers. Further, the terms “outlet”, “company outlet” and “brand outlet” are used interchangeably throughout the document and may refer to a physical location of business usually owned and operated by a retailer or a manufacturer or its franchises. Furthermore, the terms “user” and “customer” are used interchangeably throughout the document.

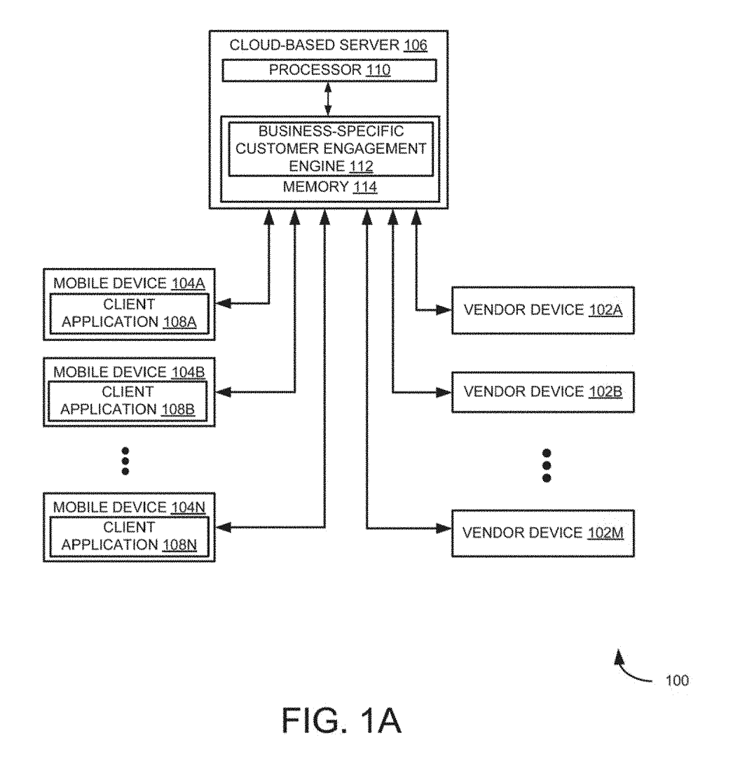

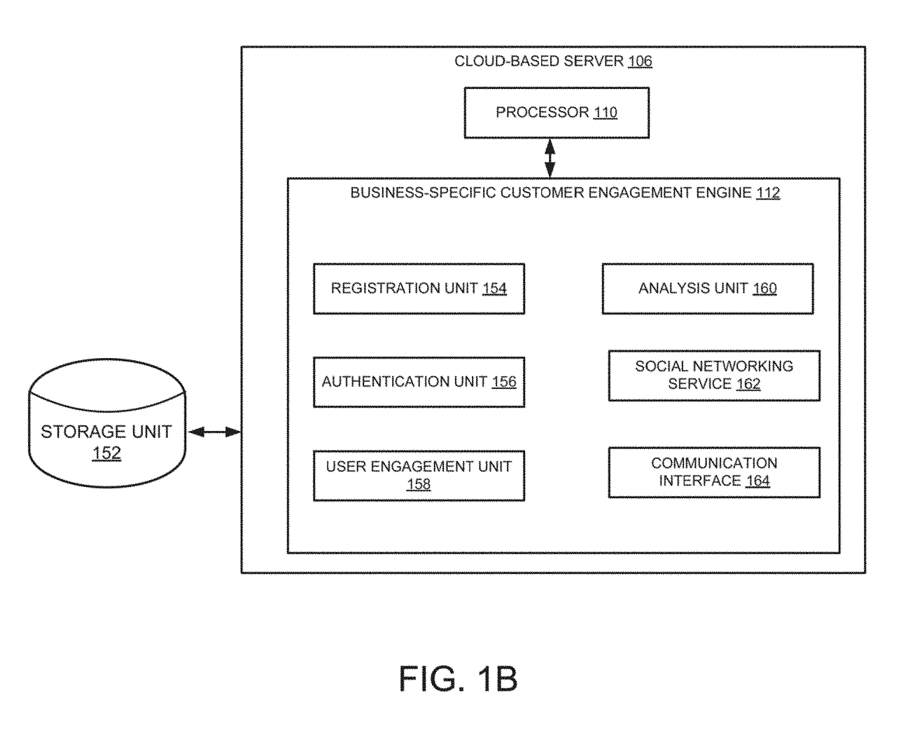

Referring to FIG. 1A, a system 100 may include a plurality of vendor devices 102A-M associated with a plurality of companies (e.g., offline businesses). In one example, each company may be a brand. For example, vendor devices 102A-M may be associated with the companies (e.g., A-M). For example, the company may be a central office/business and run or operate multiple company outlets at different geographical locations. Example vendor devices may be smart phones, laptops, tablets, PCs, and the like.

Further, the system 100 may include mobile devices 104A-N. The mobile devices 104A-N may run an associated client application 108A-N and may be associated with users. The system 100 may include a cloud-based server 106 communicatively coupled to the plurality of vendor devices (e.g., 102A-M) and the mobile devices 104A-N over a network, such as wireless network (e.g., Wi-Fi network, cellular network, and the like). The client applications 108A-N running on the mobile devices 104A-N are associated with/provided by the cloud-based server 106. Example mobile devices 104A-N may be smart phones and/or tablets. For example, mobile devices 104A-N may be configured to include the client application that enables an end-user to log into an end-user account that may be managed by the cloud-based server 106. Such end-user account, for example, may be configured to enable the end-user to receive emails, send/receive instant messages, short message service (SMS) messages, rich site summary (RSS) feeds, to access selected web pages, create and/or publish content, receive compensation, feedback, or the like.

The cloud-based server 106 may include a processor 110, memory 114 coupled to the processor 110, and a business-specific customer engagement engine 112 residing in the memory 114. The client application 108A-N may be designed for mobile devices 104A-N in communication with the business-specific customer engagement engine 112 to receive benefits and redeem them either at the physical location of a company outlet or online. The business-specific customer engagement engine 112 in the cloud-based server 106 may provide a mobile-based common platform for companies, offering electronic outlets for company-specific customer engagement. The operation/functions associated with the business-specific customer engagement engine 112 is explained in FIG. 1B.

FIG. 1B illustrates an example block diagram illustrating major components of the business-specific customer engagement engine 112 residing in the cloud-based server 106, such as shown in FIG. 1A. The cloud-based server 106 may be associated with a storage unit 152 to store information related to the users, the companies, and benefit data specific to the companies. Example benefit data specific to the companies may be selected from the group consisting of offers, news of arrival of new items or services, news and communication regarding the companies, enrollment in memberships, and loyalty programs. The benefit data specific to the companies may be obtained from respective vendor devices 102 and stored in the storage unit 152 associated with the cloud-based server 106.

The business-specific customer engagement engine 112 may include at least one communication interface 164 receiving instructions from the processor 110 to communicate with the mobile devices 104A-N and the companies (e.g., vendor devices 102A-M). The business-specific customer engagement engine 112 may include a registration unit 154 receiving instructions from the processor 110 to enable the plurality of companies and the users to subscribe with the cloud-based server 106. The storage unit 152 may store information related to the subscribed users, the subscribed companies, and benefit data specific to the subscribed companies.

The business-specific customer engagement engine 112 may include an authentication unit 156 receiving instructions from the processor 110 to authenticate a mobile device (e.g., 104A) via the communication interface 164 when the user logs-in through the client application (e.g., 108A) running on the mobile device 104A. The business-specific customer engagement engine 112 may include a user engagement unit 158 receiving instructions from the processor 110 to provide a plurality of electronic outlets associated with the plurality of companies on a user interface of the mobile device 104A through the client application 108A. In one example, each company may be associated with an electronic outlet, and comprises at least one retail store. In other words, an electronic outlet may be a virtual store representing a company/brand/business.

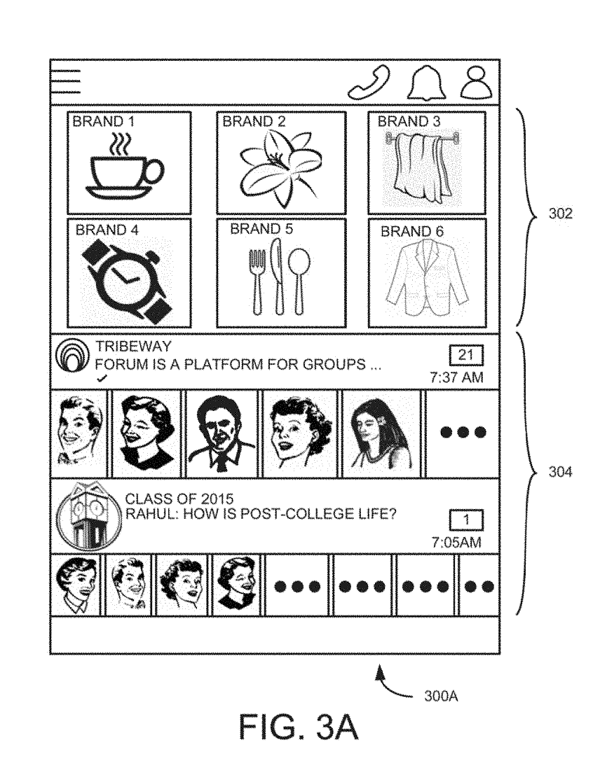

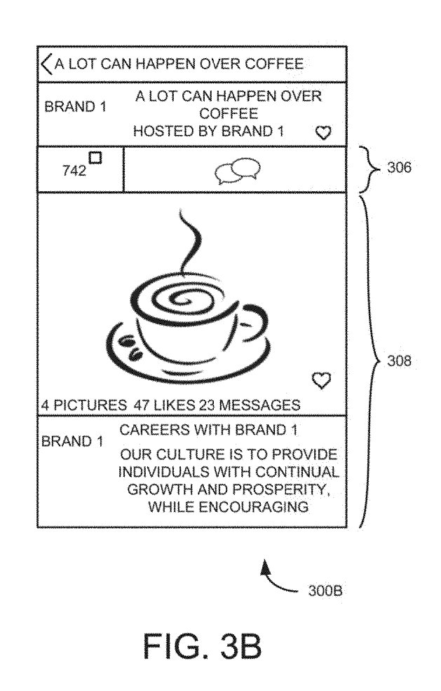

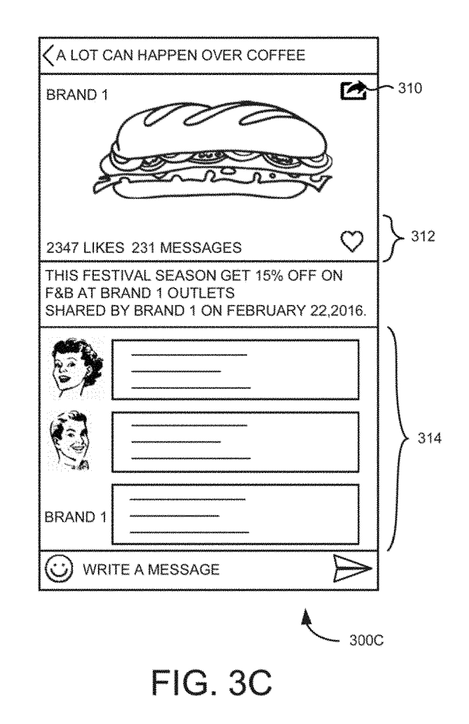

Further, user engagement unit 158 may receive a selection of a first electronic outlet associated with a first company (e.g., associated with a vendor device 102B) from the plurality of electronic outlets. Furthermore, the user engagement unit 158 may provide benefit data specific to the first electronic outlet to the mobile device 104A via the client application 108A upon the user selecting the first electronic outlet. In one example, the benefit data specific to the first company/first electronic outlet may be obtained from the vendor device 102B associated with the first company and stored in the storage unit 152 associated with the cloud-based server 106. An example user interface depicting the electronic outlets and associated benefit data is shown in FIGS. 3A and 3B. The client application 108A may be a mobile application or a web-browser based application. For example, the benefit data specific to the first electronic outlet may be provided during anniversary celebrations, silver jubilee celebrations, and the like of the first electronic outlet.

In one example, the benefit data specific to the first electronic outlet may be determined based on a user profile and historic usage data associated with the user. The benefit data is determined based on a recommendation by the user engagement unit 158 which matches the user profile with a benefit package stored in the storage unit 152. Further, the benefit data specific to the first electronic outlet may be generated in real-time, in a “personalized way” using personal preferences and may be delivered to the user or a group of users for instant redemption or a later-time redemption. The user engagement unit 158 may enable the user to avail the benefit data through an online transaction or at a retail store associated with the first electronic outlet.

The business-specific customer engagement engine 112 may include an analysis unit 160 receiving instructions from the processor 110 to capture users' demographic and behavioral data within and across the companies. For example, the demographic and behavioral data may include information selected from the group consisting of a name, address, date of birth, phone number, and email address of the users, details on user response to engagement within and across the companies. Further, the analysis unit 160 may analyze the demographic and behavioral data of the users to improve quality of marketing, engagement, offerings, reward, loyalty programs, and/or to devise new strategies to the users.

The business-specific customer engagement engine 112 may include a social networking service 162 to provide social networking capability to enable the user to share the campaigns of the companies across the users of the social networking service 162. Further, the user engagement unit 158 may enable the users to rate, like or follow the companies through the associated client application. For example, user of the mobile device 104A may be allowed to rate, like or follow the first electronic outlet and/or benefit data specific to the first electronic outlet through the client application 108A, for instance, upon availing the benefit data. An example user interface depicting a social networking capability is explained in FIG. 3C.

In one example, the components of cloud-based server 106 may be implemented in hardware, machine-readable instructions or a combination thereof. In one example, each of the registration unit 154, the authentication unit 156, the user engagement unit 158, the analysis unit 160, the social networking service 162, and the communication interface 164 may be implemented as engines or modules comprising any combination of hardware and programming to implement the functionalities described herein. Even though FIGS. 1A and 1B describe about the cloud-based server 106, the functionality of the components of cloud-based server 106 may be implemented in other electronic devices such as personal computers (PCs), server computers, tablet computers, mobile devices and the like.

The cloud-based server 106 may include computer-readable storage medium comprising (e.g., encoded with) instructions executable by the processor 110 to implement functionalities described herein in relation to FIGS. 1A and 1B. In some examples, the functionalities described herein, in relation to instructions to implement functions of the registration unit 154, the authentication unit 156, the user engagement unit 158, the analysis unit 160, the social networking service 162, and the communication interface 164 and any additional instructions described herein in relation to the storage medium, may be implemented as engines or modules comprising any combination of hardware and programming to implement the functionalities of the modules or engines described herein. The functions of components of the business-specific customer engagement engine 112 may also be implemented by the processor 110. In examples described herein, the processor may include, for example, one processor or multiple processors included in a single device or distributed across multiple devices.

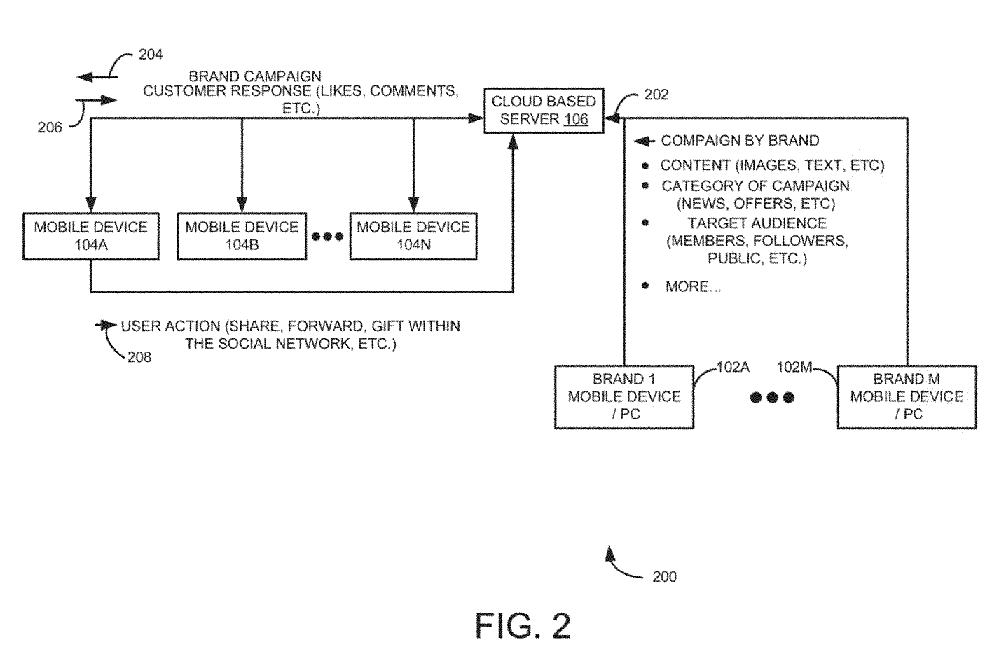

FIG. 2 illustrates an example process flow 200 between the components of the example system 100 such as shown in FIG. 1A. As shown in FIG. 2, upon subscribing with the cloud-based server 106, the brands 1-M having vendor devices 102A-M may send the benefit data specific to the brands for storing in the storage unit 152 associated with the cloud-based server (e.g., at 202). The benefit data may be sent using an installed application or browser based application in the respective vendor devices. For example, benefit data specific to the brands may include campaign by brand such as content (e.g., images, text, and the like), category of campaign (e.g., news, offers, and the like), target users/audience (e.g., members, followers, public and the like), and so on.

Further, the cloud-based server 106 may provide campaigning (e.g., benefit data) based on brands on a user interface of the users' mobile devices 104A-N (e.g., at 204). In one example, the benefit data is determined by matching the user profiles with a benefit package of the brands.

Further, the cloud-based server 106 may capture/receive user responses (e.g., likes, comments, and the like) to the brand campaign (e.g., at 206). Further, the user may be allowed to share, forward, gift the benefit data (e.g., coupon) with the friends in a social network via the social networking service 162 provided by the cloud-based server (e.g., at 208). The shared information may be captured by the cloud-based server 106. Further, the user may be allowed to converse on the benefit data and/or the brand with other users of the social networking service 162 through the mobile application.

FIG. 3A illustrates an example user interface 300A of a mobile device of a user depicting electronic outlets 302 for businesses. As shown in FIG. 3A, the electronic outlets 302 are built around a social networking platform. In the example shown in FIG. 3A, the electronic outlets 302 for businesses may include brands 1-6 and a social networking platform within the client application may enable the user to interact (e.g., chat 304) with other users through the client application.

FIG. 3B illustrates an example user interface 300B depicting customer engagement including campaigns specific to an electronic outlet (e.g., brand 1). The user interface 300B may depict an example view of details inside the electronic outlet (e.g., brand 1) when the user selects brand 1. The user interface 300B may enable the user to open discussion forum 306 within the electronic outlet (e.g., brand 1). Further, upon the user selecting brand 1 in the user interface 300A, campaign data/benefit data 308 (e.g., offers, announcements, and the like) from the brand 1 may be rendered on the user interface 300B.

FIG. 3C illustrates an example user interface 300C depicting a screen where users can leave comments about a campaign associated with brand 1. Particularly, the user interface 300C may provide an exemplary view of the details inside the campaign data 308 (e.g., offer, announcement, and the like) made by the business “brand 1” and the customer engagements around the campaign data 308. The user interface 300C depicts an option 310 to enable the user to share the campaign data/benefit data 308 associated with brand 1 with the other users in the social networking group. Further, the user interface 300C depicts an option 312 to enable the user to follow, like and boost the campaign data/benefit data 308 associated with brand 1. Also, the user interface 300C may enable the user to leave comments/converse 314 (e.g., chat) regarding the campaign data/benefit data 308 associated with brand 1. As shown in FIG. 3C, the user interface 300C depicts number of likes, messages, followers of the campaign data 308, and the like. The user can avail the benefit data either through an online transaction through the client application or at a retail store associated with brand 1.

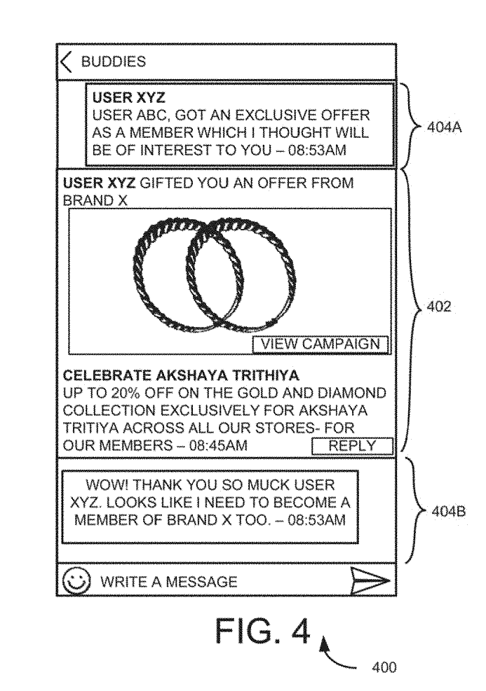

FIG. 4 illustrates an example user interface 400 depicting a social networking capability to enable campaigns of the businesses to be shared across users and to enable conversation between customers on the campaigns. The user interface 400 depicts campaign data/benefit data 402 associated with brand X that is shared to a user ABC by the user XYZ in the social networking group. Further, the user interface 400 may enable the users “XYZ” and “ABC” to converse 404A and 404B (e.g., chat) with each other regarding the campaign data/benefit data 402 associated with brand x.

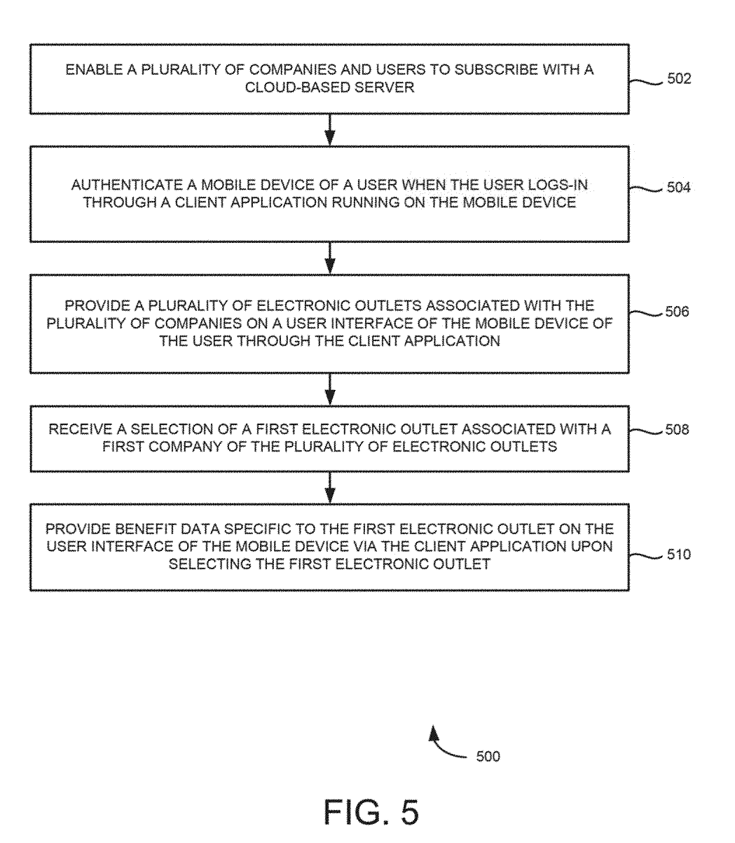

FIG. 5 illustrates an example flow chart 500 of a method for providing a mobile-based common platform offering electronic outlets for companies. It should be understood the process depicted in FIG. 5 represents generalized illustrations, and that other processes may be added or existing processes may be removed, modified, or rearranged without departing from the scope and spirit of the present application. In addition, the processes may represent instructions stored on a computer readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components associated with the system. Furthermore, the flow charts are not intended to limit the implementation of the present application, but rather the flowcharts illustrate functional information to design or fabricate circuits, generate machine-readable instructions, or use a combination of hardware and machine-readable instructions to perform the illustrated processes.

At 502, a plurality of companies and users may be enabled to subscribe with a cloud-based server by a registration unit of the cloud-based server. For example, the companies and users may be subscribed with the cloud-based server using a mobile-based application or a browser based application. Upon subscribing, information related to the users, the companies, and benefit data specific to the companies may be stored in a storage unit associated with the cloud-based server.

At 504, a mobile device of a user may be authenticated by an authentication unit of the cloud-based server when the user logs-in through a client application running on the mobile device. For example, the mobile device may be authenticated using the subscription details such as, but not limited to, a name, address, date of birth, phone number, and email address of the user and the like. At 506, a plurality of electronic outlets associated with the plurality of companies may be rendered/provided on a user interface of the mobile device of the user through the client application running on the mobile device by a user engagement unit of the cloud-based server. At 508, a selection of a first electronic outlet associated with a first company of the plurality of electronic outlets may be received by the user engagement unit.

At 510, benefit data specific to the first electronic outlet may be provided or rendered on the user interface of the mobile device via the client application by the user engagement unit upon selecting the first electronic outlet. In one example, the benefit data may be determined based on a user profile and historic usage data associated with the user. For example, historic usage data may include previous transactions made by the user corresponding to the first electronic outlet. The benefit data specific to the first company may be determined by matching the user profile with a benefit package of the first company. The benefit data specific to the first company may be obtained from a vendor device associated with the first company and stored in a storage unit associated with the cloud-based server. The benefit data specific to the first outlet may be generated and delivered to the mobile device in real-time for instant redemption or a later-time redemption.

Further, users' demographic and behavioral data may be captured within and across the companies using an analysis unit of the cloud-based server. Example demographic and behavioral data may include information selected from the group consisting of a name, address, date of birth, phone number, and email address of the users, details on user response to engagement within and across the companies. Further, the demographic and behavioral data of the users may be analyzed to improve quality of marketing, engagement, offerings, reward, and/or loyalty programs, or to devise new strategies to the users using the analysis unit.

Furthermore, a social networking capability may be provided to enable campaigns (i.e., benefit data) of the companies to be shared/forwarded/gifted across users of a social networking service using the social networking service of the cloud-based server. Further, the user may be allowed to rate, like or follow, the first company, and/or the benefit data specific to the first company through the client application.

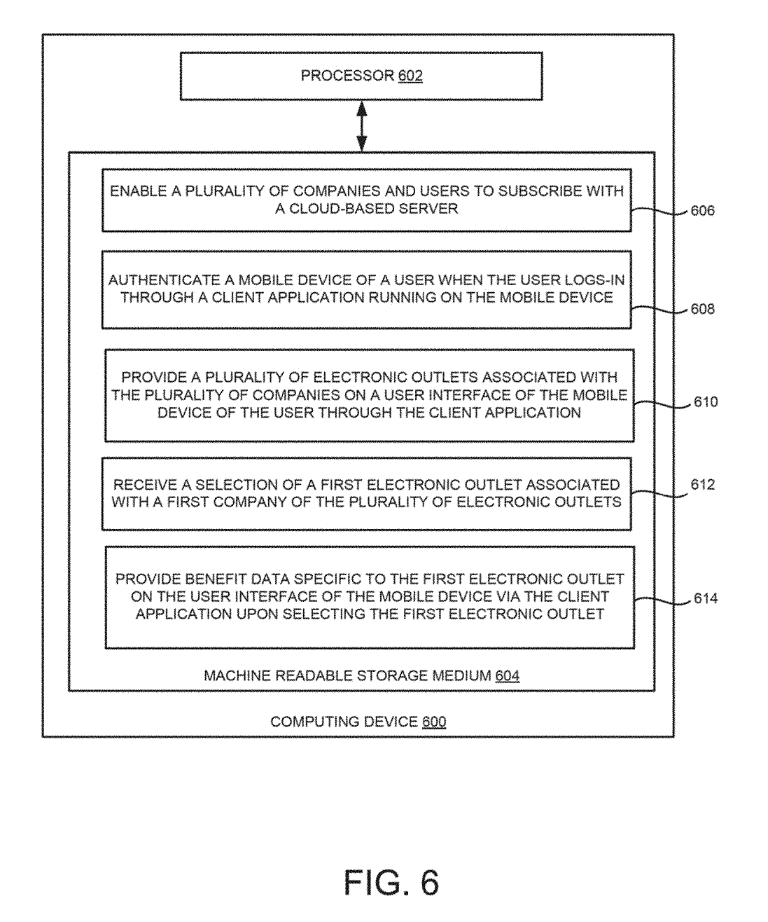

FIG. 6 illustrates a block diagram of an example computing device 600 to provide a mobile-based common platform offering electronic outlets for companies. Example computing device 600 may include a cloud-based server. Computing device 600 may include processor 602 and a machine-readable storage medium/memory 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random access memory (RAM) or another type of dynamic storage device that may store information and machine-readable instructions that may be executed by processor 602. For example, machine-readable storage medium 604 may be synchronous DRAM (SDRAM), double data rate (DDR), rambus DRAM (RDRAM), rambus RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to computing device 600.

Machine-readable storage medium 604 may store instructions 606-614. In an example, instructions 606-614 may be executed by processor 602 to provide a mobile-based common platform for company-specific customer engagement. Instructions 606 may be executed by processor 602 to enable a plurality of companies and users to subscribe with a cloud-based server by a registration unit of the cloud-based server. Instructions 608 may be executed by processor 602 to authenticate a mobile device of a user when the user logs-in through a client application running on the mobile device by an authentication unit of the cloud-based server. Instructions 610 may be executed by processor 602 to provide a plurality of electronic outlets associated with the plurality of companies on a user interface of the mobile device of the user through the client application running on the mobile device by a user engagement unit of the cloud-based server.

Instructions 612 may be executed by processor 602 to receive a selection of a first electronic outlet associated with a first company of the plurality of electronic outlets by the user engagement unit. Instructions 614 may be executed by processor 602 to provide benefit data specific to the first electronic outlet on the user interface of the mobile device via the client application by the user engagement unit upon selecting the first electronic outlet.

Also, although certain terms are used primarily herein, other terms could be used interchangeably to yield equivalent embodiments and examples. For example, the term “device” may be used interchangeably with “physical host”, “physical machine”, “physical device”, or “communication device”. Further for example, the terms “host”, “transmitting device” and “sender” may be used interchangeably throughout the document. Furthermore, the terms “client”, “recipient device”, and “receiver” may be used interchangeably throughout the document. The terms “image”, and “picture” may be used interchangeably throughout the document.

It may be noted that the above-described examples of the present solution are for the purpose of illustration only. Although the solution has been described in conjunction with a specific example thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. A system comprising:
a plurality of vendor devices associated with a plurality of companies;
at least one mobile device comprising a client application, wherein the at least one mobile device is associated with a user, and
a cloud-based server communicatively coupled to the plurality of vendor devices and the at least one mobile device, wherein the cloud-based server comprises:
a storage unit to store information related to the user, the companies, and benefit data specific to the companies;
a processor,
at least one communication interface receiving instructions from the processor to communicate with the at least one mobile device and the companies;
an authentication unit receiving instructions from the processor to authenticate the at least one mobile device via the at least one communication interface when the user logs-in through the client application;
a user engagement unit receiving instructions from the processor to:
provide a plurality of electronic outlets associated with the plurality of companies on a user interface of the at least one mobile device through the client application;
receive a selection of a first electronic outlet associated with a first company of the plurality of electronic outlets; and
provide benefit data specific to the first electronic outlet to the at least one mobile device via the client application upon the user selecting the first electronic outlet.

2. The system of claim 1, wherein the benefit data is determined based on a user profile and historic usage data associated with the user, and wherein the benefit data is determined based on a recommendation by the user engagement unit which matches the user profile with a benefit package of the first company.

3. The system of claim 1, comprising a registration unit receiving instructions from the processor to enable the plurality of companies and the user to subscribe with the cloud-based server.

4. The system of claim 1, wherein each of the plurality of companies is associated with an electronic outlet, and wherein each of the plurality of companies comprises at least one retail store.

5. The system of claim 1, wherein the at least one communication interface to enable the user to avail the benefit data through an online transaction or at a retail store associated with the first electronic outlet.

6. The system of claim 1, wherein the benefit data is selected from the group consisting of offers, news of arrival of new items or services, news and communication regarding the companies, enrollment in memberships, and loyalty programs.

7. The system of claim 1, wherein the cloud-based server comprises:
an analysis unit receiving instructions from the processor to:
capture users' demographic and behavioral data within and across the companies, wherein the demographic and behavioral data comprises information selected from the group consisting of a name, address, date of birth, phone number, and email address of users, details on user response to engagement within and across the companies; and
analyze the demographic and behavioral data of the users to improve quality of marketing, engagement, offerings, reward, loyalty programs, and/or to devise new strategies to the users.

8. The system of claim 1, wherein the cloud-based server comprises:
a social networking service to provide social networking capability to enable campaigns of the companies to be shared across the users of the social networking service by the user.

9. The system of claim 1, wherein the benefit data specific to the first company is obtained from a vendor device associated with the first company and stored in the storage unit associated with the cloud-based server.

10. The system of claim 1, wherein the user engagement unit enables the user to rate, like or follow the first company and/or the benefit data specific to the first company through the client application.

11. A cloud-based server comprising:
a storage unit to store information related to users, companies, and benefit data specific to the companies;
a processor;
at least one communication interface receiving instructions from the processor to communicate with a mobile device of a user and vendor devices associated with the companies;
an authentication unit receiving instructions from the processor to authenticate the mobile device via the at least one communication interface when the user logs-in through a client application running on the mobile device;
a user engagement unit receiving instructions from the processor to:
provide a plurality of electronic outlets associated with the plurality of companies on a user interface of the mobile device through the client application;
receive a selection of a first electronic outlet associated with a first company of the plurality of electronic outlets; and
provide benefit data specific to the first electronic outlet to the mobile device via the client application upon the user selecting the first electronic outlet.

12. The cloud-based server of claim 11, wherein the benefit data specific to the first company is obtained from a vendor device associated with the first company and stored in the storage unit associated with the cloud-based server.

13. The cloud-based server of claim 11, wherein the benefit data is determined based on a user profile and historic usage data associated with the user, and wherein the benefit data is determined based on a recommendation by the user engagement unit which matches the user profile with a benefit package of the first company.

14. The cloud-based server of claim 11, comprising a registration unit receiving instructions from the processor to enable the plurality of companies and the user to subscribe with the cloud-based server, wherein each of the plurality of companies is associated with an electronic outlet, and wherein each of the plurality of companies comprises at least one retail store.

15. The cloud-based server of claim 11, comprises:
an analysis unit receiving instructions from the processor to:
capture users' demographic and behavioral data within and across the companies, wherein the demographic and behavioral data comprises information selected from the group consisting of a name, address, date of birth, phone number, and email address of the users, details on user response to engagement within and across the companies; and
analyze the demographic and behavioral data of the users to improve quality of marketing, engagement, offerings, reward, loyalty programs, and/or to devise new strategies to the users.

16. The cloud-based server of claim 11, comprises:
a social networking service to provide social networking capability to enable campaigns of the companies to be shared across the users of the social networking service by the user.

17. The cloud-based server of claim 11, wherein the at least one communication interface to enable the user to avail the benefit data through an online transaction or at a retail store associated with the first electronic outlet.

18. The cloud-based server of claim 11, wherein the user engagement unit enables the user to rate, like or follow the first company and/or the benefit data specific to the first company through the client application.

19. A method for providing a common platform enabling electronic outlets for companies, comprising:
enabling a plurality of companies and users to subscribe with a cloud-based server by a registration unit of the cloud-based server;
authenticating a mobile device of a user when the user logs-in through a client application running on the mobile device by an authentication unit of the cloud-based server;
providing a plurality of electronic outlets associated with the plurality of companies on a user interface of the mobile device of the user through the client application running on the mobile device by a user engagement unit of the cloud-based server;
receiving a selection of a first electronic outlet associated with a first company of the plurality of electronic outlets by the user engagement unit; and
providing benefit data specific to the first electronic outlet on the user interface of the mobile device via the client application by the user engagement unit upon selecting the first electronic outlet.

20. The method of claim 19, comprising:
storing information related to the users, the companies, and benefit data specific to the companies in a storage unit associated with the cloud-based server.

21. The method of claim 19, comprising:
determining the benefit data based on a user profile and historic usage data associated with the user, and wherein the benefit data specific to the first company is determined by matching the user profile with a benefit package of the first company.

22. The method of claim 19, wherein the benefit data specific to the first company is obtained from a vendor device associated with the first company and stored in a storage unit associated with the cloud-based server.

23. The method of claim 19, comprising:
capturing users' demographic and behavioral data within and across the companies using an analysis unit of the cloud-based server, wherein the demographic and behavioral data comprises information selected from the group consisting of a name, address, date of birth, phone number, and email address of the users, details on user response to engagement within and across the companies; and
analyzing the demographic and behavioral data of the users to improve quality of marketing, engagement, offerings, reward, loyalty programs, and/or to devise new strategies to the users using the analysis unit.

24. The method of claim 19, comprising:
providing social networking capability to enable campaigns of the companies to be shared across users of a social networking service using the social networking service of the cloud-based server.

25. The method of claim 19, comprising:
enabling the user to rate, like or follow the first company and/or the benefit data specific to the first company through the client application.

26. A non-transitory computer-readable storage medium comprising instructions executable by a cloud-based server to:
enable a plurality of companies and users to subscribe with a cloud-based server by a registration unit of the cloud-based server;
authenticate a mobile device of a user when the user logs-in through a client application running on the mobile device by an authentication unit of the cloud-based server;
provide a plurality of electronic outlets associated with the plurality of companies on a user interface of the mobile device of the user through the client application running on the mobile device by a user engagement unit of the cloud-based server;
receive a selection of a first electronic outlet associated with a first company of the plurality of electronic outlets by the user engagement unit; and
provide benefit data specific to the first electronic outlet on the user interface of the mobile device via the client application by the user engagement unit upon selecting the first electronic outlet.

27. The non-transitory computer-readable storage medium of claim 26, comprising instructions to determine the benefit data based on a user profile and historic usage data associated with the user, and wherein the benefit data specific to the first company is determined by matching the user profile with a benefit package of the first company.

28. The non-transitory computer-readable storage medium of claim 26, comprising:
capture users' demographic and behavioral data within and across the companies, wherein the demographic and behavioral data comprises information selected from the group consisting of a name, address, date of birth, phone number, and email address of the users, details on user response to engagement within and across the companies; and
analyze the demographic and behavioral data of the users to improve quality of marketing, engagement, offerings, reward, loyalty programs, and/or to devise new strategies to the users.
